(19) United States
(12) Patent Application Publication
(10) Pub. No.: US 2026/0152037 A1
(43) Pub. Date: Jun. 4, 2026

(54) METHOD FOR OPERATING A MOTOR VEHICLE, MOTOR VEHICLE AND ELECTRIC MACHINE, AND AIR-CONDITIONING SYSTEM FOR A MOTOR VEHICLE

(71) Applicant: AUDI AG, Ingolstadt (DE)

(72) Inventors: Steffen TRIEBE, Delitzsch (DE); Philipp UHLMANN, Ingolstadt (DE); Korbinian WEBER, Ingolstadt (DE)

(21) Appl. No.: 19/406,811

(22) Filed: Dec. 2, 2025

(30) Foreign Application Priority Data
Dec. 3, 2024 (DE) 102024135810.6

(51) Int. Cl. B60H 1/00; B60H 1/32; B60K 1/00

(52) U.S. Cl. CPC B60H 1/00392; B60H 1/3208; B60H 1/3223; B60K 2001/006

(57) ABSTRACT

A method for operating a motor vehicle which comprises an electric machine forming a traction motor and an air-conditioning system for air-conditioning a passenger compartment is provided, wherein a refrigerant present on the part of the air-conditioning system is compressed by way of a compressor of the air-conditioning system, and wherein an internal pressure in an interior of the electric machine, in which a rotor is rotatably mounted, is reduced by way of the same compressor of the air-conditioning system.

### BACKGROUND

### Technical Field

The present disclosure relates to a method for operating a motor vehicle which comprises an electric machine forming a traction motor and an air-conditioning system for air-conditioning a passenger compartment, wherein a refrigerant present on the part of the air-conditioning system is compressed by way of a compressor of the air-conditioning system.

### Description of the Related Art

Modern motor vehicles typically comprise air-conditioning systems that can be used to condition the air present in a passenger compartment of the motor vehicle. Such air-conditioning systems often implement refrigerant circuits or refrigerant systems in which a compressor for a refrigerant is integrated.

Furthermore, electric machines are increasingly being used as traction motors in modern motor vehicles. In these motor vehicles, which are electric or hybrid vehicles, a drive torque and possibly a braking torque can be generated by way of the electric machine. However, this results in high air friction losses caused by a rotor of the electric machine, particularly at high rotational speeds, which is disadvantageous in terms of maximizing the possible range of the motor vehicle.

To counter this problem, the prior art proposed lowering an internal pressure in the interior of the electric machine, for example, in CN108462294A, CN108667214A or CN212435523U.

### BRIEF SUMMARY

Embodiments of the invention provide an improved concept for reducing air friction loss caused by a rotor of the electric machine.

According to embodiments of the invention, this is achieved in a motor vehicle which comprises an electric machine forming a traction motor and an air-conditioning system for air-conditioning a passenger compartment, in that an internal pressure in the interior of the electric machine, in which a rotor is rotatably mounted, is reduced by way of the compressor of the air-conditioning system.

Embodiments of the invention are based on using the compressor provided by the air-conditioning system in a synergistic manner not only for the purpose of air-conditioning the passenger compartment, but also to reduce the internal pressure in the electric machine. This eliminates the need for a separate pump to reduce the internal pressure, thus saving additional components, which is advantageous in terms of the required installation space, the resulting total weight and the costs incurred.

The electric machine may be connected to an electrical energy store of the motor vehicle, which can also be referred to as a traction battery or an energy storage device. The energy required to propel the motor vehicle may be stored in the energy store. The electric machine is used to convert the electrical energy provided by the energy store into the kinetic energy of the motor vehicle. For this purpose, the electric machine is connected to a drivetrain of the motor vehicle, via which a traction torque or, if applicable, a braking torque can be transmitted between the wheels of the motor vehicle and the electric machine.

In addition to the rotor, the electric machine comprises a stator, wherein electromagnetic interactions between field coils and, if applicable, permanent magnets, which are present on the part of the rotor and the stator, are used for the aforementioned energy conversion. Preferably, the electric machine comprises a housing. The rotor and the stator can be arranged in the housing. While the stator is stationary in relation to the housing, the rotor is rotatably mounted inside the housing. It is conceivable that the inside of the fluid-tight or gas-tight housing represents the interior.

The passenger compartment, which can also be referred to as a passenger cell, is typically occupied by the vehicle's occupants during the journey. The passenger compartment can be air-conditioned by way of the air-conditioning system. In particular, the airflow to be introduced into the passenger compartment may be conditioned in terms of temperature and, if necessary, humidity by way of the air-conditioning system. For this purpose, air can be drawn in from outside the motor vehicle and/or from the passenger compartment, which then forms the airflow. The air-conditioning system can implement a cooling system, in particular a refrigerant circuit. The compressor can be integrated or be integrable into the cooling system or refrigerant circuit. The refrigerant circulates within the refrigerant circuit and optionally undergoes several phase transitions from liquid to gaseous and vice versa. Further components, such as an expansion valve, a condenser and/or an evaporator, can be integrated into the refrigerant circuit. A heat exchanger can be integrated into the refrigerant circuit, via which heat is transferable from the airflow to the refrigerant and which is optionally the evaporator.

The compressor is preferably a fluid pump by way of which a gas, i.e., the air present in the interior and/or the gaseous and/or liquid refrigerant, can be conveyed. The energy required to operate the compressor or, generally speaking, the components of the air-conditioning system can be provided by the energy store.

According to the disclosure, control signals may be generated by a control device, which cause the compressor to be operated in an air-conditioning mode, in which it compresses the refrigerant, or in a pressure-reduction mode, in which it reduces the internal pressure. The control signals generated by the control device, therefore, preferably cause at least one of the steps of the method according to the disclosure to be carried out. It is conceivable that the compressor in the air-conditioning mode only compresses the refrigerant and is therefore not used to reduce the internal pressure. It is also conceivable that the compressor in the pressure-reduction mode is used only to reduce the internal pressure and therefore not to compress the refrigerant. In principle, however, mixed operation is also conceivable, in which the compressor simultaneously compresses the refrigerant and reduces the internal pressure.

Preferably, at least one portion of operating information relating to a current and/or future state of the motor vehicle is determined, wherein the control signals are generated on the basis of the at least one portion of operating information. The operating information can relate to the current and/or future status of the electric machine and/or the air-conditioning system. At least one portion of operating information therefore represents a control basis with regard to whether the compressor is currently reducing the internal pressure or compressing the refrigerant, or both.

The operating information or one of the portions of operating information can be pressure information relating to the current and/or future internal pressure. The energy loss resulting from the rotational movement of the rotor depends on the internal pressure, whereby the higher the internal pressure, the higher the energy loss. Signals recorded by a pressure sensor device can be used to record the pressure information. The sensor signals can thus be transmitted to the control device, wherein the sensor signals represent the pressure information or the pressure information is determined using the sensor signals.

In addition or alternatively, it is conceivable that the operating information, or one of the portions of operating information, is rotational speed information relating to a current and/or future rotational speed of the rotor. Thus, the energy loss resulting from the rotational movement of the rotor depends not only on the internal pressure but also on the current rotational speed of the rotor, whereby the higher the speed, the higher the energy loss. The rotational speed information can be available as part of a vehicle control system. For example, the vehicle control system may know that the current rotational speed of the motor has a certain value, wherein this value is transmitted to the control device as the rotational speed information. A future rotational speed of the motor can also be known as part of the vehicle control system by knowing, for example, on the basis of a planned route, that a phase with increased rotational speed is imminent, wherein this information can be used to determine the rotational speed information relating to the future rotational speed.

It is particularly advantageous that the fulfillment of a pressure reduction condition is checked by the control device and on the basis of the at least one portion of operating information. The pressure reduction condition is only fulfilled or can only be fulfilled if the at least one portion of operating information shows that a reduction of the internal pressure is currently indicated, wherein the control signals are generated and output by the control device in such a way that the compressor switches to the pressure reduction mode or remains in it. Thus, when fulfilling the pressure reduction condition, it can be assumed that a reduction of the internal pressure is advantageous or expedient. For example, the pressure reduction condition can be fulfilled if at least one portion of operating information indicates that an energy loss occurring on the part of the rotor is not negligibly small or is sufficiently significant.

The reduction condition can only be fulfilled or is fulfillable if the pressure information indicates that the current and/or future internal pressure exceeds a pressure threshold and/or if the rotational speed information indicates that the current and/or future rotational speed of the rotor exceeds a speed threshold. The respective threshold can be fixed or determined on a situation-specific basis. Thus, the pressure threshold can be specified on the basis of the rotational speed information in such a way that the reduction of the internal pressure is appropriate when the pressure threshold is reached and the corresponding rotational speed is present. Similarly, the speed threshold can be specified on the basis of the pressure information in such a way that when the speed threshold is reached and the corresponding pressure is present, the reduction of the internal pressure is appropriate. Thus, the pressure reduction condition can be fulfilled or be fulfillable, and the reduction of the internal pressure can be expedient if, in particular in the context of an energy balancing, it results from the at least one portion of operating information that the energy required to reduce the internal pressure due to the operation of the compressor is less than the energy loss occurring, in particular to be expected, on the part of the rotor. The respective threshold value can be specified on the basis of the other information in such a way that if it is exceeded, the energy loss to be expected on the part of the rotor exceeds the energy required to reduce the internal pressure by way of the compressor.

The motor vehicle can comprise a valve device, wherein the valve device can be transferred from an air-conditioning state to a pressure-reduction state and vice versa by way of the control signals, wherein the compressor is integrated into a cooling system carrying the refrigerant by way of the valve device located in the air-conditioning state in order to realize the air-conditioning mode. The compressor is connected to the interior by way of the valve device located in the pressure-reduction state in order to realize the pressure-reduction mode. The valve device can comprise at least one valve whose position can be controlled by way of the control signals. The valve can be controlled electrically, for example, directly by way of the control signals. The valve can be controlled hydraulically or pneumatically, wherein the corresponding hydraulic or pneumatic system can be controlled by way of the control signals.

The valve device preferably has an inlet valve and an outlet valve. The inlet valve can have an outlet that is connected to a suction-side inlet of the compressor. Furthermore, the inlet valve can have two inlets, one of which is connected to the interior and the other to a refrigerant line of the cooling system upstream of the compressor. The outlet valve can have an inlet that is connected to a pressure-side outlet of the compressor. Furthermore, the outlet valve can have two outlets, one of which is connected to a discharge line for discharging the gas extracted from the interior by way of the compressor, and the other to a refrigerant line of the cooling system downstream of the compressor. The inlet valve and/or the outlet valve may be connected directly upstream and/or downstream of the compressor. The gas extracted from the interior can be discharged to the surroundings of the motor vehicle by way of the exhaust line. A filter device can be provided in the area of the exhaust line, by way of which, for example, oil present in this gas, which is used as a refrigerant and/or lubricant for the electric machine and is therefore present in the interior, can be filtered out or separated from the gas.

The present disclosure further relates to an electric machine for a motor vehicle, which can be used as a traction motor of the motor vehicle, wherein the motor vehicle comprises an air-conditioning system for air-conditioning a passenger compartment, and wherein a refrigerant present on the part of the air-conditioning system can be compressed by way of a compressor of the air-conditioning system. The electric machine has an interface for coupling the electrical machine to the compressor, so that an internal pressure in the interior of the electrical machine, in which a rotor is rotatably mounted, can be reduced by way of the compressor. All the advantages, features and aspects explained in connection with the method according to the disclosure are equally transferable to the electric machine according to the disclosure and vice versa.

The interface of the electric machine can be a connection piece. A connector, for example, an air hose, can be connected to the interface of the electric machine to connect the compressor to the electric machine.

In addition, the disclosure relates to an air-conditioning system for a motor vehicle, by way of which a passenger compartment of the motor vehicle can be air-conditioned, wherein a refrigerant present on the part of the air-conditioning system can be compressed by way of a compressor of the air-conditioning system, and wherein the motor vehicle comprises an electric machine forming a traction motor. The air-conditioning system has an interface for connecting the electric machine to the compressor, so that an internal pressure in the interior of the electric machine, in which a rotor is rotatably mounted, can be reduced by way of the compressor. All the advantages, features and aspects explained in connection with the method according to the disclosure and/or the electric machine according to the disclosure are equally transferable to the air-conditioning system according to the disclosure and vice versa.

The interface of the air-conditioning system can be a connection piece. The aforementioned connector, for example, the air hose, can be connected to the interface of the air-conditioning system to connect the air-conditioning system, specifically the compressor, to the electric machine.

Finally, the present disclosure relates to a motor vehicle comprising an electric machine forming a traction motor and an air-conditioning system for air-conditioning a passenger compartment, wherein a refrigerant present on the part of the air-conditioning system can be compressed by way of a compressor of the air-conditioning system. In this motor vehicle, an internal pressure in the interior of the electric machine, in which a rotor is rotatably mounted, can be reduced by way of the compressor. All the advantages, features and aspects explained in connection with the method according to the disclosure and/or the electric machine according to the disclosure and/or the air-conditioning system according to the disclosure are equally transferable to the motor vehicle according to the disclosure and vice versa.

### BRIEF DESCRIPTION OF THE SEVERAL VIEWS OF THE DRAWINGS

FIG. 1 is a schematic top view of a motor vehicle according to an exemplary embodiment, comprising an electric machine and an air-conditioning system;

FIG. 2 is the same representation of the motor vehicle as in FIG. 1, with the compressor in an air-conditioning mode,

FIG. 3 is the same representation of the motor vehicle as in FIG. 1, with the compressor in a pressure-reduction mode, and

FIG. 4 is a flow diagram of a method according to the disclosure, according to an exemplary embodiment, which is carried out in the motor vehicle of FIG. 1-3.

### DETAILED DESCRIPTION

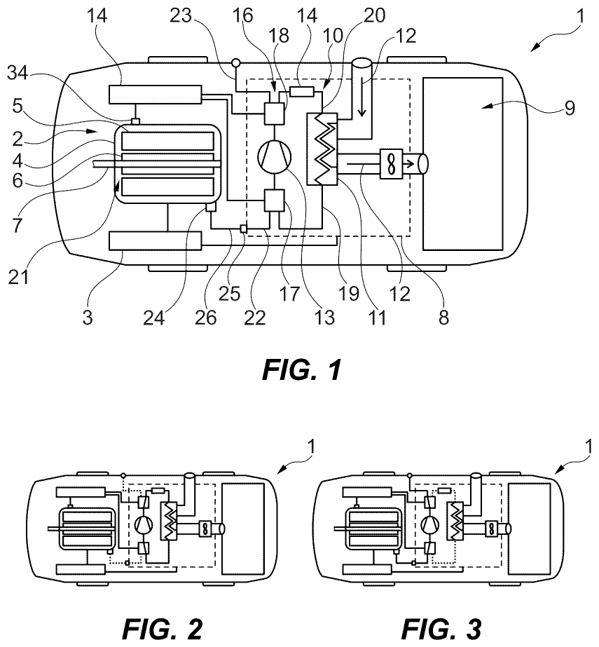

FIG. 1 shows a schematic top view of a motor vehicle 1 according to an exemplary embodiment of the disclosure. The motor vehicle 1 comprises an electric machine 2 according to an exemplary embodiment of the disclosure, which forms a traction motor and is connected to an electric energy store 3 or a traction battery. The electric machine 2 comprises a housing 4, as well as a stator 5 arranged therein, and a rotatably mounted rotor 6. To transmit a drive torque generated by the energy from the energy store 3 to the wheels of the motor vehicle 1, the electric machine 2, specifically a shaft of the rotor 6, is connected to a drivetrain 7 of the motor vehicle 1.

Furthermore, the motor vehicle 1 comprises an air-conditioning system 8 for air-conditioning a passenger compartment 9 in which the passengers of the motor vehicle 1 are located during the journey. The air-conditioning system 8 comprises or forms a cooling system 10, which is designed as a refrigerant circuit in which a refrigerant circulates. A heat exchanger 11 is integrated into the refrigerant circuit, via which heat can be transferred from an airflow 12 to be introduced into the passenger compartment 9 to the refrigerant. In the present case, the air forming the airflow 12 is drawn in from outside the motor vehicle 1 and can additionally or alternatively originate from the passenger compartment 9. Furthermore, a compressor 13 is integrated into the refrigerant circuit, by way of which the refrigerant is compressed and the circulation of the refrigerant in the refrigerant circuit is driven. Further components 14 of the refrigerant circuit, such as an expansion valve, a condenser and/or the like, are symbolically indicated in FIG. 1.

Furthermore, the motor vehicle 1 comprises a control device 14, by way of which control signals 15 can be generated, which cause the compressor 13 to be operated in an air-conditioning mode or in a pressure-reduction mode. For this purpose, the control signals 15 are output to a valve device 16, specifically to an inlet valve 17 and an outlet valve 18 of the valve device 16, whose valve positions can be adjusted by way of the control signals 15. In this way, the control signals 15 cause the valve device 16 to be brought into an air-conditioning state in order to bring the compressor 13 into the air-conditioning mode. The control signals 15 also cause the valve device 16 to be brought into a pressure-reduction state in order to bring the compressor 13 into pressure-reduction mode.

FIGS. 2 and 3 show the same representation of the motor vehicle 1 as FIG. 1, wherein the compressor 13 is in the air-conditioning mode in FIG. 2 and in the pressure-reduction mode in FIG. 3. In FIGS. 2 and 3, lines that are decoupled from the compressor 13 by way of the valve device 16 or are not connected to the compressor 13 are indicated as dotted lines. For the sake of clarity, no reference signs are shown in FIG. 2 and FIG. 3, and reference is made to FIG. 1 in this regard.

Reference is now made to FIG. 2, i.e., to the air-conditioning mode. In this state, the compressor 13 is integrated into the cooling system 10 by way of the valve device 16 in order to implement the air conditioning of the passenger compartment 9. For this purpose, an inlet on the suction side of the compressor 13 is connected to a refrigerant line 19 of the cooling system 10 upstream of the compressor 13, which connects the heat exchanger 11 to the compressor 13. An outlet on the pressure side of the compressor 13 is connected to a refrigerant line 20 of the cooling system 10 downstream of the compressor 13, which connects the compressor 13 to the heat exchanger 11.

Reference is now made to FIG. 3, i.e., to the pressure-reduction mode. In this state, the compressor 13 is connected by way of the valve device 16 to an interior space 21 of the electric machine 2, in which the rotor 6 is rotatably mounted and which is realized by the interior of the housing 4. For this purpose, the suction-side inlet of the compressor 13 is connected to a line 22 leading to the interior 21. The pressure-side outlet of the compressor 13 is connected to an exhaust line 23, via which gas extracted from the interior 21 by the compressor 13 can be discharged to the surroundings of the motor vehicle 1. The compressor 13, which is in pressure-reduction mode, can therefore be used to reduce the internal pressure in the interior 21, so that energy loss due to air friction caused by the rotation of the rotor 6 is reduced or avoided.

In summary, and as can be seen from FIGS. 1-3, the inlet valve 17 comprises two inlets, one of which is connected to the line 22 leading to the interior 21 and the other to the refrigerant line 19 upstream of the compressor 13. Furthermore, the inlet valve 17 comprises an outlet that is connected to the suction-side inlet of the compressor 13. The outlet valve 18 comprises an inlet, which is connected to the pressure-side outlet of the compressor 13, and two outlets, one of which is connected to the exhaust line 23 and the other to the refrigerant line 20 downstream of the compressor 13. In the air-conditioning state of the valve device 16, the inlet valve 17 connects the refrigerant line 19 to the suction-side inlet of the compressor 13, and the outlet valve 18 connects the pressure-side outlet of the compressor 13 to the refrigerant line 20. In the pressure-reduction state of the valve device 16, the inlet valve 17 connects the line 22 to the suction-side inlet of the compressor 13, and the outlet valve 18 connects the pressure-side outlet of the compressor 13 to the exhaust line 23.

To connect the electric machine 2 to the air-conditioning system 8, i.e., the interior 21 to the line 22, the electric machine 2 has an interface 24 and the air-conditioning system 8 has an interface 25, which are connected by a connector 26. The interfaces 24, 25 are each a connection piece, which are connected by the connector 26 in the form of an air hose.

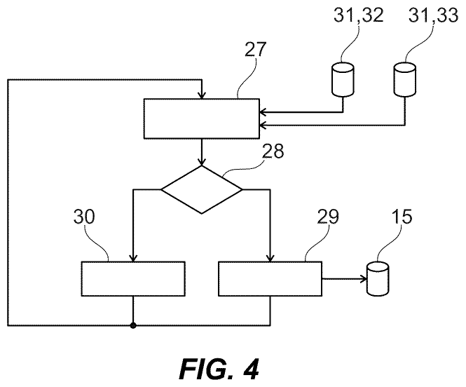

Reference is made below to FIG. 4, which shows a flow chart of a method according to the disclosure in accordance with an exemplary embodiment. The method comprising steps 27-30 is carried out in the motor vehicle 1, as explained with reference to FIG. 1-3. The control device 14, which is connected to the corresponding components via signal lines, is set up to implement the method.

In the first step 27, operating information 31 is determined, namely, pressure information 32 and rotational speed information 33. The pressure information 32 relates to a current and/or possibly future internal pressure present in the interior 21. To determine the pressure information 32, measurement signals from a pressure sensor device 34 are transmitted to the control device 14. The rotational speed information 33 relates to a current and/or, where appropriate, future rotational speed of the rotor 6. To determine the rotational speed information 33, the corresponding information is retrieved from a vehicle control unit, by way of which the operation of the electric machine 2 is controlled, and transmitted to the control device 14.

In the next step 28, the control device 14 checks whether a pressure-reduction condition has been met using the operating information 31. The pressure-reduction condition is fulfilled if the pressure information 32 indicates that the internal pressure exceeds a predetermined pressure threshold. In addition or alternatively, the pressure-reduction condition is fulfilled if the rotational speed information 33 indicates that the rotational speed exceeds a predefined speed threshold. Specifically, the pressure-reduction condition is fulfilled if the operating information 31 shows that the energy required to reduce the internal pressure due to the operation of the compressor 13 is less than the energy loss occurring on the part of the rotor 5. In the following, two conceivable, concrete variants are explained in this regard, in the context of which an energy balance is carried out in each case.

According to the first variant, the speed threshold is determined on the basis of the pressure information 32 in such a way that, if the internal pressure is present according to the pressure information 32, exceeding the speed threshold by the rotational speed results in the energy loss to be expected on the part of the rotor 6 exceeding the energy required for reducing the internal pressure by way of the compressor 13.

According to the second variant, the pressure limit value is determined on the basis of the speed information 33 in such a way that, if the speed of the rotor 6 is in accordance with the speed information 33, exceeding the pressure of the pressure limit value results in the energy loss to be expected on the part of the rotor 6 exceeding the energy required for reducing the internal pressure by way of the compressor 13.

With regard to steps 29, 30, it is assumed that the compressor 13 is currently in the air-conditioning mode. Thus, if the pressure-reduction condition is fulfilled, the control signals 15 are generated in step 29 in such a way that they cause the valve device 16 to be transferred from the air-conditioning state to the pressure-reduction state and thus the compressor 13 to the pressure-reduction mode. Otherwise, i.e., if the pressure-reduction condition is not met, step 30 skips step 29 and the generation of the control signals 15, so that the compressor 13 remains in the air-conditioning mode. The method is then restarted from the beginning with the renewed recording or updating of the operating information 31.

Finally, the case is explained with regard to steps 29, 30, in which the compressor 13 is currently in the pressure-reduction mode. Thus, in this case, if the pressure-reduction condition is not fulfilled, the control signals 15 are generated in step 29 in such a way that they cause the valve device 16 to be transferred from the pressure-reduction state to the air-conditioning state and thus the compressor 13 to the air-conditioning state. Otherwise, if the pressure-reduction condition is fulfilled, step 30 virtually skips step 29 and the generation of the control signals 15, so that the compressor 13 remains in the pressure-reduction mode. Here too, the method starts again from the beginning with the renewed recording or updating of the operating information 31.

German patent application no. 102024135810.6 filed Dec. 3, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a motor vehicle which includes an electric machine forming a traction motor and an air-conditioning system for air-conditioning a passenger compartment, the method comprising:
compressing a refrigerant present in the air-conditioning system by a compressor of the air-conditioning system; and
reducing an internal pressure in an interior of the electric machine, in which a rotor is rotatably mounted, by the same compressor of the air-conditioning system.

2. The method according to claim 1, further comprising:
generating control signals by a control device, which causes the compressor of the air-conditioning system to be operated in an air-conditioning mode, in which the compressor compresses the refrigerant, or to be operated in a pressure-reduction mode, in which the compressor reduces the internal pressure in the interior of the electric machine.

3. The method according to claim 2, further comprising:
determining at least one item of operating information, which relates to a current and/or future state of the motor vehicle, and
wherein generating the control signals includes generating the control signals on the basis of at least one portion of the at least one item of operating information.

4. The method according to claim 3, wherein the at least one item of operating information or the at least one portion of the at least one item of operating information is pressure information, which is detected by signals of a pressure sensor device and relates to a current and/or future internal pressure of the electric machine.

5. The method according to claim 3, wherein the at least one item of operating information or the at least one portion of the at least one item of operating information is rotational speed information, which relates to a current and/or future rotational speed of the rotor.

6. The method according to claim 3, further comprising:
checking the fulfillment of a pressure-reduction condition by the control device and on the basis of the at least one portion of the at least one item of operating information, which condition is only fulfilled or can be fulfilled if the at least one portion of the at least one item of operating information shows that a reduction in the internal pressure is currently indicated; and
generating and outputting the control signals by the control device in such a way that the compressor switches to the pressure-reduction mode or remains in the pressure-reduction mode.

7. The method according to claim 6, wherein the pressure-reduction condition is only fulfilled or can only be fulfilled if the at least one item of pressure information indicates that a current and/or future internal pressure exceeds a pressure threshold value and/or if the rotational speed information indicates that a current and/or future rotational speed of the rotor exceeds a speed threshold value.

8. The method according to claim 6, wherein the pressure-reduction condition is fulfilled or can be fulfilled if it is apparent from the at least one portion of the at least one item of operating information that the energy required to reduce the internal pressure due to the operation of the compressor is less than the energy loss occurring on the part of the rotor.

9. The method according to claim 2, wherein the motor vehicle comprises a valve device, and wherein the method further comprises:
transferring, by way of the control signals, the valve device from an air-conditioning state to a pressure-reducing state and vice versa,
wherein the compressor is integrated into a cooling system carrying the refrigerant via the valve device, which is positionable in the air-conditioning state, in order to realize the air-conditioning mode, and
wherein the compressor is connected to the interior of the electric machine via the valve device, which is positionable in the pressure-reduction state, in order to realize the pressure-reduction mode.

10. The method according to claim 9, wherein the valve device has an inlet valve and an outlet valve, wherein the inlet valve has an outlet which is connected to a suction-side inlet of the compressor, and two inlets, one of which is connected to the interior of the electric machine and the other to a refrigerant line of the cooling system upstream of the compressor, wherein the outlet valve has an inlet, which is connected to a pressure-side outlet of the compressor, and two outlets, one of which is connected to an exhaust line for discharging the gas extracted from the interior by way of the compressor, and the other to a refrigerant line of the cooling system downstream of the compressor.

11. An electric machine for a motor vehicle, which is configured to be used as a traction motor of the motor vehicle, wherein the motor vehicle includes an air-conditioning system for air-conditioning a passenger compartment, wherein a refrigerant present in the air-conditioning system is compressible by a compressor of the air-conditioning system, the electric machine comprising:
an interface for connecting the electric machine to the compressor of the air-conditioning system, so that an internal pressure in an interior of the electric machine (2), in which a rotor is rotatably mounted, is able to be reduced by the compressor.

12. An air-conditioning system for a motor vehicle, by which a passenger compartment of the motor vehicle can be air-conditioned, the motor vehicle including an electric machine forming a traction motor, the air-conditioning system comprising:
a compressor;
a refrigerant that can be compressed by the compressor;
an interface for connecting the electric machine to the compressor of the air-conditioning system, so that an internal pressure in an interior of the electric machine, in which a rotor is rotatably mounted, is able to be reduced by the compressor.

13. A motor vehicle, comprising:
an electric machine forming a traction motor; and
an air-conditioning system for air-conditioning a passenger compartment of the motor vehicle,
wherein a refrigerant in the air-conditioning system is compressible by a compressor of the air-conditioning system, and
wherein an internal pressure in an interior of the electric machine, in which a rotor is rotatably mounted, is able to be reduced by the compressor of the air-conditioning system.
